(19) United States
(12) Patent Application Publication
(10) Pub. No.: US 2023/0298811 A1
(43) Pub. Date: Sep. 21, 2023

(54) CURRENT TRANSFORMER

(71) Applicant: Siemens Energy Global GmbH & Co. KG, Munich, Bayern (DE)

(72) Inventor: Emanuele Gastaldo, Basaluzzo (IT)

(73) Assignee: Siemens Energy Global GmbH & Co. KG, Munich, Bayern (DE)

(21) Appl. No.: 18/018,994

(22) PCT Filed: Aug. 13, 2020
(86) PCT No.: PCT/EP2020/072748

§ 371 Date: Jan. 31, 2023

(51) Int. Cl. H01F 38/30; H01F 27/29; H01F 27/32

(52) U.S. Cl. CPC H01F 38/30; H01F 27/29; H01F 27/32

(57) ABSTRACT

A current transformer includes a head tank and a head tank cover, both of an electrically conductive material, a primary winding for conducting a current to be measured. The primary winding has a primary bar, and a secondary winding is wound around the primary bar. The primary and secondary windings are arranged within a cavity defined within the head tank and cover. An upper flange of the head tank is configured for fluid tightly sealing against a cover flange of the head tank cover. The head tank and cover respectively have a primary terminal for electrically contacting the primary winding. One or more connection points are within the head tank and cover, respectively, to electrically connect a respective end of the primary winding to the head tank or to the cover, wherein an electrically insulating ring is arranged between the cover flange and the upper flange.

### CROSS REFERENCE TO RELATED APPLICATIONS

This application is the US National Stage of International Application No. PCT/EP2020/072748 filed 13 Aug. 2020, and claims the benefit thereof, and is incorporated by reference herein in its entirety.

### FIELD OF INVENTION

The invention relates to a current transformer.

### BACKGROUND OF INVENTION

Conventional transformers typically have a primary circuit separated from the rest of the transformer. This aspect introduces limitations in the design, assembling and materials.

The primary circuit in conventional designs comprises multiple parts, i.e. primary bar, terminal, return bar and connection, all separated from the transformer. This results in a time-consuming assembly, possible human errors and technical limits. The major limitation of this solution is that there cannot be more than four turns.

In an exemplary conventional transformer the primary bars are inside an aluminum tube which is filled with a resin. Between the tube and a tank of the transformer there are insulation (insulated bushing) and oil tightness (O-ring). The terminals of the primary bars are insulated from the tank and the windings are completed with copper and return bars.

### SUMMARY OF INVENTION

It is an object of the present invention to provide an improved current transformer.

The object is achieved by a current transformer according to the independent claim.

Advantageous embodiments of the invention are subject of the dependent claims.

A current transformer according to the invention comprises a head tank and a head tank cover, both comprising or consisting of an electrically conductive material, at least one primary winding for conducting a current to be measured, the primary winding comprising at least one primary bar, and a secondary winding wound around the at least one primary bar, the primary and secondary windings arranged within a cavity defined within the head tank and head tank cover arranged on the head tank, wherein an upper flange of the head tank is configured for fluid tightly sealing against a cover flange of the head tank cover, wherein the head tank and the head tank cover respectively comprise a primary terminal for electrically contacting the primary winding, wherein one or more connection points are provided within the head tank and within the head tank cover, respectively, to electrically connect a respective end of the primary winding to the head tank or to the head tank cover, wherein an electrically insulating ring is arranged between the cover flange and the upper flange.

In an exemplary embodiment, the primary winding comprises a number of primary bars extending in parallel and a number of return conductors connecting one respective primary bar to another one, wherein the return conductors are wound around the secondary winding.

In an exemplary embodiment, the return conductors are located within the cavity defined within the head tank and head tank cover. Integrating the whole primary winding with the head leads to reduction in cost and manufacturing time and a more rational use of materials.

In an exemplary embodiment, the primary winding comprises or consists of paper insulated copper wire, e.g. a multi paper covered copper conductor. The paper may be an electrical crepe insulating paper. An alternative insulation of the wire may be kraft (i.e. an insulating paper), thermally upgraded kraft, cotton, electrical insulation created from a blend of high-quality, electrical-grade cellulose pulp and web-like binders made from high-temperature aramid polymer, polyethylene terephthalate.

In an exemplary embodiment, the head tank and/or the head tank cover comprise/s a bowl shape.

In an exemplary embodiment, the head tank and/or the head tank cover have/has a rectangular cross section with rounded corners.

In an exemplary embodiment, the head tank tapers in a downward direction and/or wherein the head tank cover tapers in an upward direction with regard to an operating position.

In an exemplary embodiment, at a bottom, the head tank comprises an opening and/or wherein at a top, the head tank cover comprises an opening.

In an exemplary embodiment, a lower flange is provided at a bottom of the head tank configured for mounting the head tank on top of an isolator configured to lead the terminals of the secondary winding through.

In an exemplary embodiment, the head tank comprises a landing providing a widened space beneath the upper flange to receive the return conductors wound around the secondary winding.

In an exemplary embodiment, the primary terminals comprise a first primary terminal and a second primary terminal, wherein the first primary terminal extends basically radially from the head tank with respect to a longitudinal axis and/or wherein the second primary terminal extends basically radially from the head tank cover with respect to the longitudinal axis.

In an exemplary embodiment, the first primary terminal extends from the upper flange and/or the second primary terminal extends from the cover flange.

In an exemplary embodiment, one of the connection points is provided on the landing.

In an exemplary embodiment, the connection point comprises a portion of increased thickness, wherein one or more threaded holes are provided in the connection point to allow for securing the end of the primary winding or a cable lug attached thereto by means of a respective screw.

In an exemplary embodiment, one or more handling tabs extend radially from the head tank.

In an exemplary embodiment, two handling tabs are arranged opposite each other near the upper flange.

In an exemplary embodiment, the handling tabs comprise a respective handling hole configured for connecting a dee shackle.

In an exemplary embodiment, the handling hole extends basically in a tangential direction with respect to the longitudinal axis.

In an exemplary embodiment, the second primary terminal is cranked so as to be located at the same height with the first primary terminal when the head tank cover is arranged on the head tank.

In an exemplary embodiment, the head tank cover is mounted on the head tank in such a way that the first primary terminal and the second primary terminal extend in opposite directions.

In an exemplary embodiment, the cover flange comprises a plurality of cover flange holes and the upper flange comprises a plurality of corresponding upper flange holes configured to allow for securing the head tank cover on the head cover by screws.

In an exemplary embodiment, the upper flange holes or the cover flange holes are threaded and/or configured as blind holes.

In an exemplary embodiment, two or more electrically parallel primary windings are provided, wherein the return conductors of one of the primary windings is lead about one side of the secondary winding and the return conductors of another one of the primary windings is lead about an opposite side of the secondary winding.

In an exemplary embodiment, the upper flange and the cover flange comprise a respective circumferential notch in which a respective O-ring is arranged to seal the upper flange and the cover flange against the insulating ring.

In an exemplary embodiment, in each cover flange hole and/or in each upper flange hole, a respective electrically insulating axle box is arranged and the screws are lead through the axle boxes.

In an exemplary embodiment, the insulating ring and/or the axle box are made of PTFE, Polyoxymethylene or HDPE.

The above described characteristics, features and advantages of this invention and the way in which they are achieved will become apparent from the detailed description of embodiments given hereinafter, which will be explained in reference to the accompanying drawings.

### BRIEF DESCRIPTION OF THE DRAWINGS

FIG. 1 is a schematic view of an exemplary embodiment of a current transformer,

FIG. 2 is a schematic sectional view of the current transformer,

FIG. 3 is another schematic sectional view of the current transformer,

FIG. 4 is a schematic view of a head tank of the current transformer,

FIG. 5 is a schematic sectional view of the head tank,

FIG. 6 is a schematic top view of the head tank,

FIG. 7 is a schematic view of a head tank cover of the current transformer,

FIG. 8 is a schematic sectional view of the head tank cover,

FIG. 9 is a schematic top view of the head tank with primary windings and secondary windings, and

FIG. 10 is a schematic detail view of the current transformer.

### DETAILED DESCRIPTION OF INVENTION

Corresponding parts are marked with the same reference symbols in all figures.

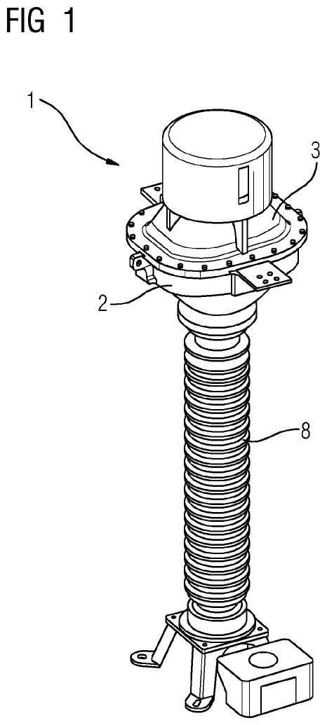

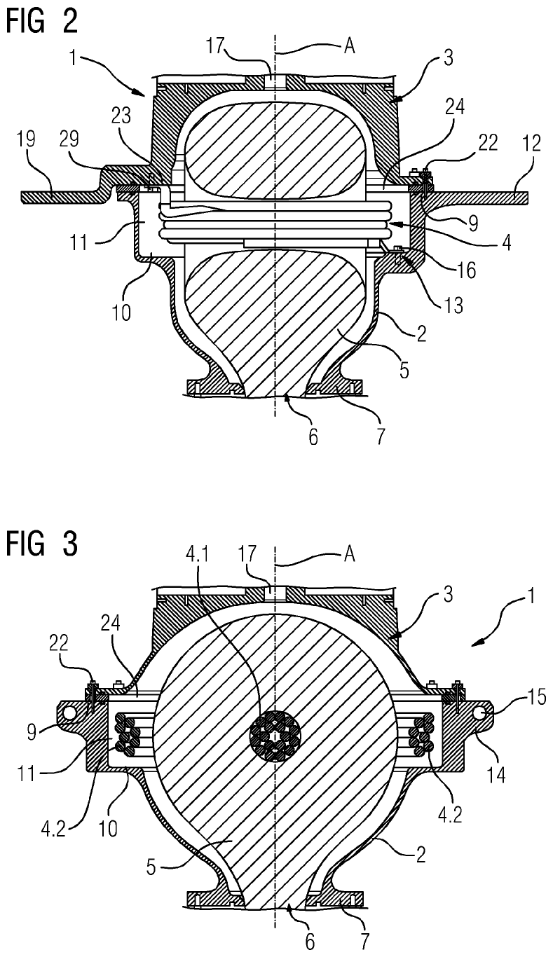

FIG. 1 is a schematic view of an exemplary embodiment of a current transformer 1. FIGS. 2 and 3 are schematic sectional views of the current transformer 1. The current transformer 1 comprises a head, comprising a head tank 2 and a head tank cover 3, a primary winding 4 for conducting a current to be measured, the primary winding 4 comprising a number of primary bars 4.1 extending in parallel and a number of return conductors 4.2 connecting one respective primary bar 4.1 to another one. The primary winding 4 and in particular its return conductors 4.2 are located within the head of the current transformer 1. The primary winding 4 may consist of paper insulated copper wire. A secondary winding 5 is wound around the primary bars 4.1 and serves for measuring the current flowing through the primary winding 4. The return conductors 4.2 are wound around the secondary winding 5.

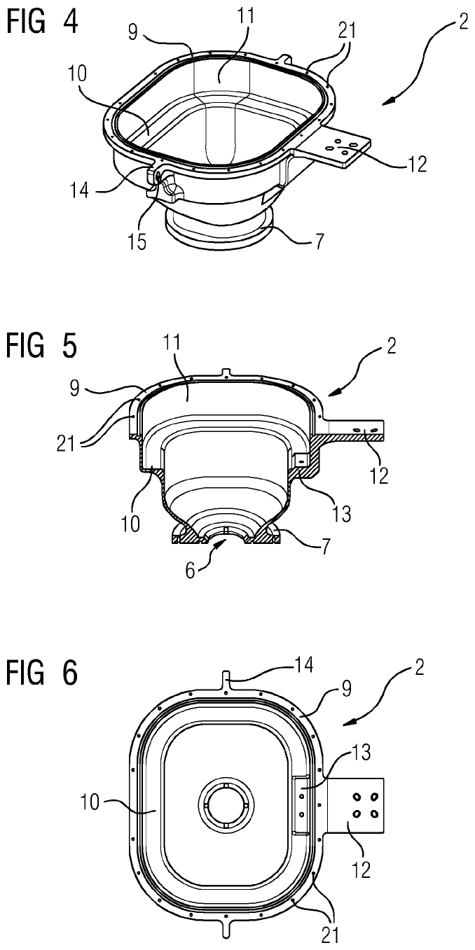

FIG. 4 is a schematic view of the head tank 2. FIG. 5 is a schematic sectional view of the head tank 2. FIG. 6 is a schematic top view of the head tank 2.

The head tank 2 consists of an electrically conductive material, e.g. a metal, and is basically shaped like a bowl having a rectangular cross section with rounded corners and tapering in a downward direction with regard to an operating position. In other embodiments, the head tank 2 may have a different shape. At a bottom, the head tank 2 comprises an opening 6 to lead terminals of the secondary windings 5 through. Moreover, a lower flange 7 may be provided at the bottom of the head tank 2 configured for mounting the head tank 2 on top of an isolator 8 through which the terminals of the secondary winding 5 may be lead. An upper flange 9 of the head tank 2 is configured for interfacing to the head tank cover 3. Moreover, the head tank 2 comprises a landing 10 providing a widened space 11 beneath the upper flange 9 to receive the return conductors 4.2. The head tank 2 may comprise a first primary terminal 12 incorporated in the casting of the head tank 2 for electrically contacting the current transformer 1 and the primary winding 4. The first primary terminal 12 may extend basically radially with respect to a longitudinal axis A like a tab from the head tank 2, for example from the upper flange 9, and may comprise holes for allowing a conductor to be screwed to the first primary terminal 12. One or more connection points 13 are provided within the head tank 2 to electrically connect a respective end of the primary winding 4 to the head tank 2. The connection point 13 may be provided on the landing 10 and may comprise a portion of increased thickness relative to the rest of the landing. One or more threaded holes may be provided in the connection point 13 to allow for securing the end of the primary winding 4 or a cable lug attached thereto by means of a respective screw 16, e.g. an M10 screw. In an exemplary embodiment, at one or more handling tabs 14 may extend radially from the head tank 2, in particular two handling tabs 14 arranged opposite each other near the upper flange 9. The handling tabs 14 may comprise a respective handling hole 15 allowing for connecting a dee shackle. The handling hole 15 may extend basically in a tangential direction with respect to the longitudinal axis A.

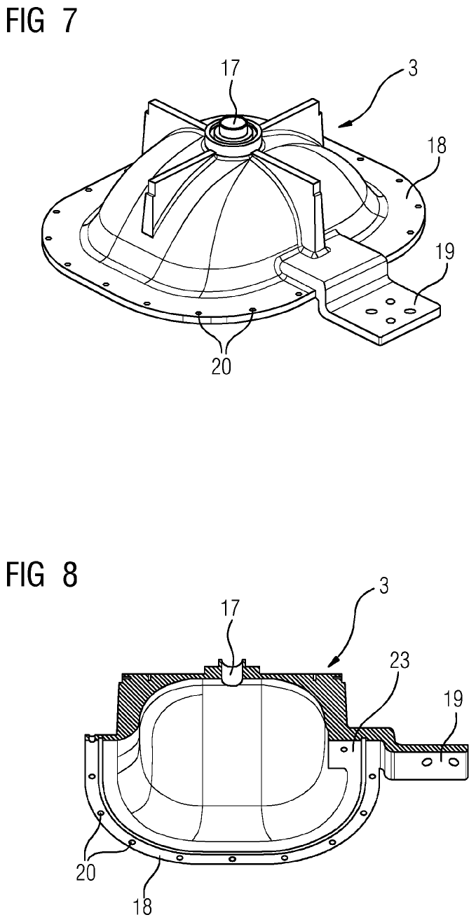

FIG. 7 is a schematic view of the head tank cover 3. FIG. 8 is a schematic sectional view of the head tank cover 3.

The head tank cover 3 consists of an electrically conductive material, e.g. a metal, and is basically shaped like a bowl having a rectangular cross section with rounded corners and tapering in an upward direction with regard to an operating position. In other embodiments, the head tank cover 3 may have a different shape. At a top, the head tank cover 3 comprises a cover opening 17, e.g. to connect to a bellow and/or other accessories. A cover flange 18 of the head tank cover 3 is configured for interfacing to the upper flange 9 of the head tank 2. The head tank cover 3 may comprise a second primary terminal 19 incorporated in the casting of the head tank cover 3 for electrically contacting the current transformer 1 and the other end of the primary winding 4. The second primary terminal 19 may extend basically radially with respect to a longitudinal axis A like a tab from the head tank cover 3, for example from the cover flange 18, and may comprise holes for allowing a conductor to be screwed to the second primary terminal 19. The second primary terminal 19 may be cranked so as to be located at the same height with the first primary terminal 12 when the head tank cover 3 is arranged on the head tank 2. In a particular embodiment, the head tank cover 3 may be mounted on the head tank 2 in such a way that the first primary terminal 12 and the second primary terminal 19 extend from the current transformer 1 in opposite directions.

The cover flange 18 may comprise a plurality of cover flange holes 20 and the upper flange 9 may comprise a plurality of corresponding upper flange holes 21 to allow for securing the head tank cover 3 on the head tank 2 by screws 22. The upper flange holes 21 or the cover flange holes 20 may be threaded and may be configured as blind holes.

One or more cover connection points 23 are provided within the head tank cover 3 to electrically connect a respective end of the primary winding 4 to the head tank cover 3. The cover connection point 23 may comprise a portion of increased thickness relative to the rest of the head tank cover 3 at this position along the longitudinal axis A. One or more threaded holes may be provided in the cover connection point 23 to allow for securing the end of the primary winding 4 or a cable lug attached thereto by means of a respective screw 29, e.g. an M10 screw.

When the head tank cover 3 is mounted to the head tank 2, an insulating ring 24 may be placed between the cover flange 18 and the upper flange 9 to electrically insulate the head tank cover 3 from the head tank 2.

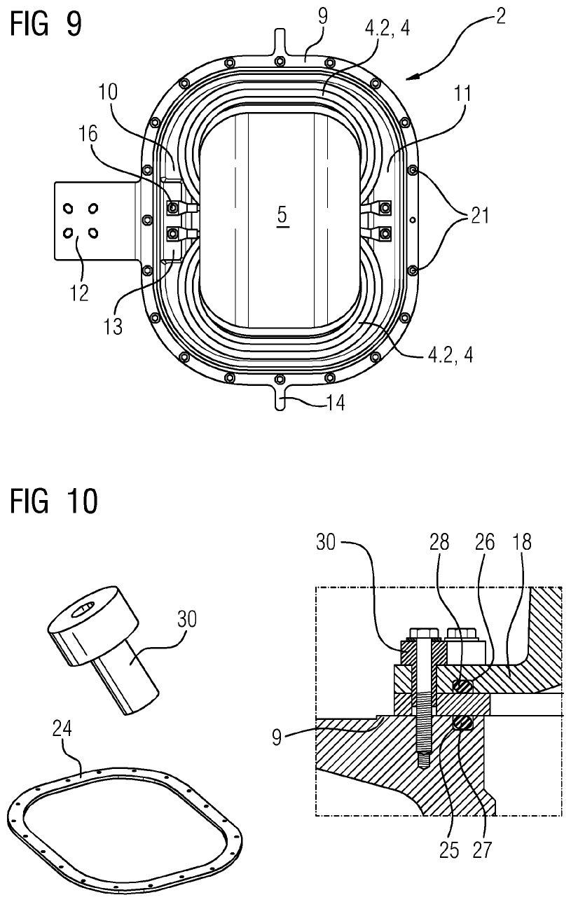

FIG. 9 is a schematic top view of the head tank 2 with primary windings 4 and secondary windings 5. In this configuration, two parallel primary windings 4 are provided, wherein the return conductors 4.2 of one primary winding 4 is lead about one side of the secondary winding 5 and the return conductors 4.2 of the other primary winding 4 is lead about an opposite side of the secondary winding 5.

FIG. 10 is a schematic detail view of the current transformer 1 showing an interface between the upper flange 9 and the cover flange 18 with the insulating ring 24 arranged between them. Both the upper flange 9 and the cover flange 18 comprise a respective circumferential notch 25, 26 in which a respective O-ring 27, 28 is arranged to seal the upper flange 9 and the cover flange 18 against the insulating ring 24 so that oil held within the cavities of the current transformer 1 cannot leak out.

In each cover flange hole 20, a respective axle box 30 made from an electrically insulating material is arranged and the screws 22 are lead through the axle boxes 30 thus keeping the head tank 2 and the head tank cover 3 electrically insulated from one another.

The insulating ring 24 and/or the axle box 30 may for example be made of PTFE, Polyoxymethylene or HDPE.

When the current transformer 1 is electrically contacted at the first primary terminal 12 and the second primary terminal 19, the electric current flows from the first primary terminal 12 through the head tank 2, the connection point 13, the primary winding 4, the cover connection point 23, the head tank cover 3 and to the second primary terminal 19 and/or vice versa. This current can be indirectly measured by measuring a typically much weaker current induced in the secondary winding 5.

The solution according to the invention allows for arranging more than four turns, e.g. eight turns, of primary bars 4.1 through the secondary winding 5.

It is possible to have, with the same properties, from one to ten turns or more with different current values (e.g. 100 turns or more).

The current transformer according to the invention may be leaner compared to conventional current transformers.

As opposed to conventional current transformers, the primary windings 4 are electrically connected to the head tank 2 and to the head tank cover 3. In this way inconvenient leakages from oil held within the internal cavities out into the environment and leakage of air from the environment into the current transformer 1 can be avoided. In addition, in the configuration shown in FIG. 9 with the two primary windings 4 in parallel there are only four screws 16, 22 that need to be tightened for assembling the primary circuit, thus reducing the human error, the assembling time and the procurement of a lot of materials.

The economic saving may be 20% compared with a conventional current transformer with similar properties.

The main advantages of the solution according to the invention may be:
Improved flexibility in primary circuit design,
no limitation in number of turns of the primary winding,
possible use in wound current transformer for very low current,
cheaper,
no contact between external part and oil held within the current transformer,
leaner design,
reduced probability for human error during assembly,
faster assembly,
lighter, smaller, therefore easier packaging and shipping,
no special tools required for assembly, and
standard impregnation treatment applicable.

Although the invention has been shown and described in detail by preferred embodiments, those of skill in the art will understand that modifications (additions and/or removals) of various components of the apparatuses, methods and/or systems and embodiments described herein may be made without departing from the full scope and spirit of the present invention, which encompass such modifications and any and all equivalents thereof.

1. A current transformer comprising:
a head tank and a head tank cover, both comprising or consisting of an electrically conductive material,
at least one primary winding for conducting a current to be measured, the primary winding comprising at least one primary bar, and
a secondary winding wound around the at least one primary bar,
wherein the primary and secondary windings are arranged within a cavity defined within the head tank and head tank cover arranged on the head tank,
wherein an upper flange of the head tank is configured for fluid tightly sealing against a cover flange of the head tank cover,
wherein the head tank and the head tank cover respectively comprise a primary terminal for electrically contacting the primary winding,
wherein one or more connection points are provided within the head tank and within the head tank cover, respectively, to electrically connect a respective end of the primary winding to the head tank or to the head tank cover,
wherein an electrically insulating ring is arranged between the cover flange and the upper flange.

2. The current transformer according to claim 1,
wherein the primary winding comprises a number of primary bars extending in parallel and a number of return conductors connecting one respective primary bar to another one, wherein the return conductors are wound around the secondary winding.

3. The current transformer according to claim 2,
wherein the return conductors are located within the cavity defined within the head tank and head tank cover.

4. The current transformer according to claim 1,
wherein the primary winding comprises or consists of paper insulated copper wire.

5. The current transformer according to claim 2,
wherein the head tank comprises a landing providing a widened space beneath the upper flange to receive the return conductors wound around the secondary winding.

6. The current transformer according to claim 1,
wherein the primary terminals comprise a first primary terminal and a second primary terminal, wherein the first primary terminal extends basically radially from the head tank with respect to a longitudinal axis and/or wherein the second primary terminal extends basically radially from the head tank cover with respect to the longitudinal axis.

7. The current transformer according to claim 1,
wherein the connection point comprises a portion of increased thickness, wherein one or more threaded holes are provided in the connection point to allow for securing the end of the primary winding or a cable lug attached thereto by means of a respective screw.

8. The current transformer according to claim 1,
wherein one or more handling tabs extend radially from the head tank.

9. The current transformer according to claim 8,
wherein the handling tabs comprise a respective handling hole configured for connecting a dee shackle.

10. The current transformer according to claim 6,
wherein the second primary terminal 494 is cranked so as to be located at the same height with the first primary terminal when the head tank cover is arranged on the head tank.

11. The current transformer according to claim 6,
wherein the head tank cover is mounted on the head tank in such a way that the first primary terminal and the second primary terminal extend in opposite directions.

12. The current transformer according to claim 1,
wherein the cover flange comprises a plurality of cover flange holes and the upper flange comprises a plurality of corresponding upper flange holes configured to allow for securing the head tank cover on the head tank by screws, wherein the upper flange holes or the cover flange holes are threaded and/or configured as blind holes, wherein in each cover flange hole and/or in each upper flange hole, a respective electrically insulating axle box is arranged and the screws are lead through the axle boxes.

13. The current transformer according to claim 2,
wherein two or more electrically parallel primary windings are provided, wherein the return conductors of one of the primary windings are lead about one side of the secondary winding and the return conductors of another one of the primary windings are lead about an opposite side of the secondary winding.

14. The current transformer according to claim 1,
wherein the upper flange and the cover flange comprise a respective circumferential notch in which a respective O-ring is arranged to seal the upper flange and the cover flange against the insulating ring.

15. The current transformer according to claim 1,
wherein the insulating ring and/or an axle box are made of PTFE, Polyoxymethylene or HDPE.
